(19) United States
(12) Patent Application Publication
(10) Pub. No.: US 2013/0097584 A1
(43) Pub. Date: Apr. 18, 2013

(54) MAPPING SOFTWARE MODULES TO SOURCE CODE

(71) Applicants: Michal Ayash, Jerusalem (IL); Avigail Oron, Petach Tikiva (IL)

(72) Inventors: Michal Ayash, Jerusalem (IL); Avigail Oron, Petach Tikiva (IL)

(21) Appl. No.: 13/275,340

(22) Filed: Oct. 18, 2011

(51) Int. Cl. G06F 9/44

(52) U.S. Cl. 717/121

(57) ABSTRACT

A class map is created based on source code for a subject program that includes program modules. The class map maps the program modules to object-oriented programming classes referenced by the source code. A log map is created based on the class map and logging-mechanism configuration files. The logging-mechanism configuration files map the classes to log files. The log map maps the program modules to log files.

### BACKGROUND

Software developers often write programs in human-readable source code, which is then compiled into executable code. When a program is to be updated, e.g., to add features, to improve performance, or to address problems, the source code is typically edited and the edited source code is then compiled into fresh executable code.

### BRIEF DESCRIPTION OF THE DRAWINGS

The following figures represent examples and not the invention itself.

FIG. 1 is a schematic diagram of a system for mapping a program module to its source code in accordance with an example.

FIG. 2 is a schematic diagram of an alternative system for mapping a program module to its source code in accordance with an example.

FIG. 3 is a graphical representation of a support version of a program developed, tested, and used by the system of FIG. 2.

FIG. 4 is a representation of a log map of program modules to source-code modules and log files used in the system of FIG. 2.

FIG. 5 is a flow chart of a process implemented by the system of FIG. 2.

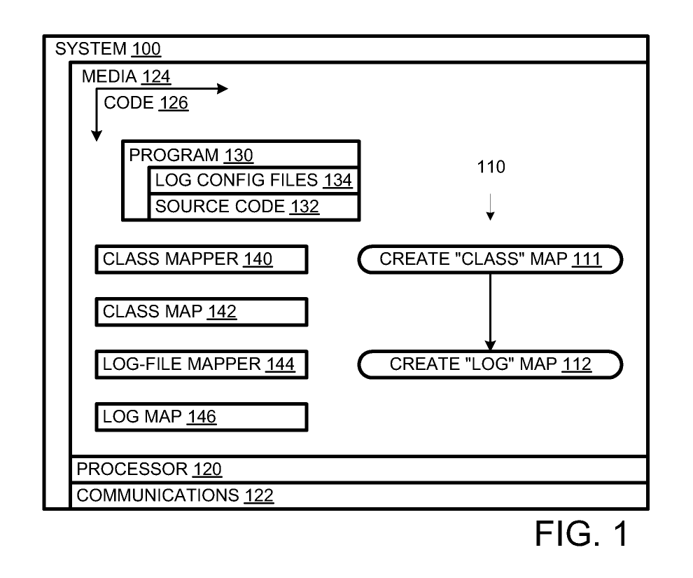

### DETAILED DESCRIPTION

A system 100 implements a process 110 involving creating a “class” map of program modules to classes accessed by respective programming modules from object-oriented programming source code at 110, and creating a “log” map of program modules to log files accessed by respective program modules from the class map and logging mechanism configuration files. The log map can be used to allow a support engineer or other agent to quickly identify the log files associated with a given program module. Also, the class map can be used to allow an engineer to quickly access the source code classes associated with a given program module. The log map and the class map can be generated automatically, relieving engineers/developers from the burden of determining what to look for and where to begin doing so. Also, the maps are generated once, rather than separately for different engineers/developers who may be focuses on different aspects of a system.

System 100 includes a processor 120, communications devices 122, and non-transitory computer-readable storage media 124. Media 124 is encoded with code 126 defining process 110. From another perspective, code 126 defines a program 130, which can include source code 132 and log configuration files 134. Source code 132 defines one or more logging mechanisms for logging events into log files 134 when a byte-code or executable version of program 130 is executing. Code 126 further defines a class mapper 140, a class map 142, a log-file mapper 144, and a log map 146.

Class mapper 140 implements process segment 111, which involves creating class map 142 from source code 132. Class map 142 associates (maps) program modules to respective classes accessed while respective program modules are executing. Log-file mapper 144 implements process segment 112, which involves creating log map 146 (which maps program modules to log files) from class map 142 (which maps program modules to classes) and logging-mechanism configuration files 134 (which map classes to log files).

Herein, a “map” is a data structure that associates names of one or more source entities (e.g., program modules) with names of one or more target entities (e.g., classes and/or log files). Herein, a “program module” is any portion of a program that can be identified or treated as a module. For example, a program module can be a web page, in which case, the program module's name can be the title of the web page. For another example, a program module can be configured to be called by another program, in which case, the name can be the name used by the other program to call the program module. The program modules of interest herein refer to some but not all the classes and log files referred to by the program as a whole.

In one scenario, a user reports a problem with an application program to the application program vendor. The report specifies a program module (e.g., the user provides a screen shot of the context in which the problem occurred) along with a description of any actions taken that lead to the problem. For example, the program module can be dialog box and the application may have stopped working when a “next” button was activated.

In this scenario, a support engineer can use log map 146 to determine the pertinent log files to examine to address the user's problem. Log files not identified by log map 146 as associated with the program module need not be accessed. Thus, log map 146 can save a support engineer considerable time and effort in identifying relevant log files. If the support engineer suspects the problem is related to a bug in the source code, the class map 142 can be used to identify the relevant classes.

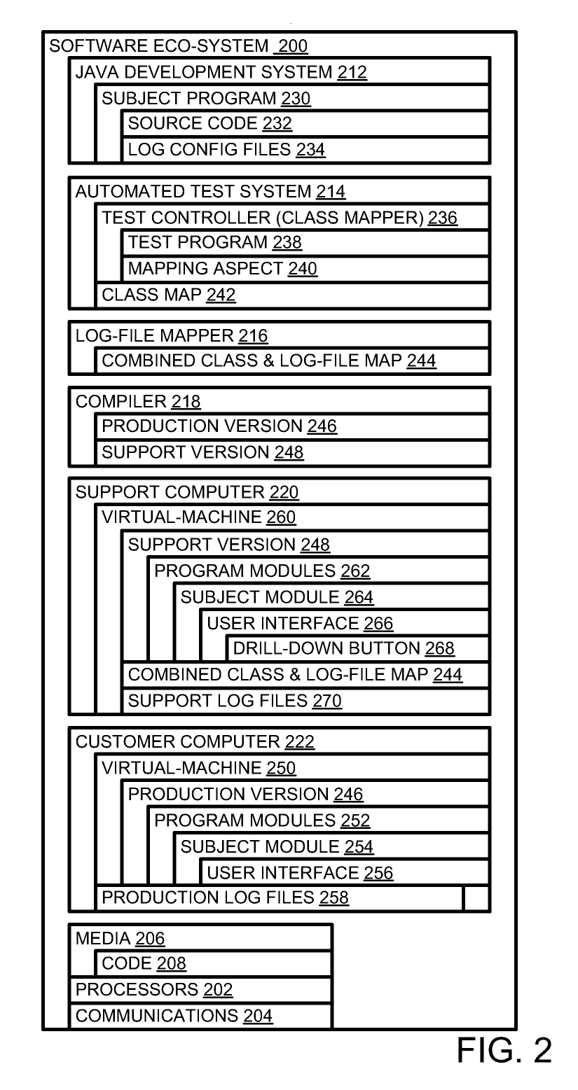

A software eco-system 200, shown in FIG. 2, includes processors 202, communications devices 204, and non-transitory computer-readable storage media 206. Media 206 is encoded with code 208 that defines the functionality of programmed hardware entities including a JAVA development system 212, an automated test system 214, a log-file mapper 216, a compiler 218, a support computer 220, and a customer computer 222.

JAVA development system 212 is used by programmers to create a subject program 230 in the form of source code 232 and logging-mechanism configuration (“log config”) files 234. Source code 232 can define one or more logging mechanisms that record events into log files.

Automated test system 214 includes a programmed-hardware test controller 236 for logic testing of source code 232. Test controller includes a test program 238 (e.g., a test suite), and a mapping aspect 240 attached to test program 238. Mapping aspect 240, which can be a JAVA aspect, keeps track of the relationships between program modules and classes, e.g., by referring to the packages containing the classes. Operation of mapping aspect 240 results in a class map 242, which maps program modules to classes.

Log-file mapper 216 extends class map 242 to create a combined. class and log-file map 244 by transitively associating program-module-to-class associations in class map 242 with class-to-log-file associations in logging-mechanism configuration files 234.

Compiler 218 is use to convert source code 232 into a production byte-code version 246 and a support byte-code version 248 of subject program 230. A copy of production byte-code version 246 runs on a virtual-machine 250, which itself runs on customer computer 222. Production version 246 includes program modules 252 including a subject module 254, which has a user interface 256. As production version 246 is executed, events are logged into production log files 258.

In the event of a problem with subject module 254 of production version 246, a user may contact a support engineer who has access to corresponding support version 248 running on a virtual machine 260 on support computer 220. Support version 248 includes program modules 262, which correspond to program modules 252 of production version 246. More specifically, program modules 262 include a subject module which corresponds to subject module 254 of production version 246. However, the user interface 266 for support subject module 264 includes a drill-down button 268 that the user interface 256 for production subject module 254 lacks. Support computer 220 also stores support log files 270, which correspond to production log files 258. In addition, support computer 220 stores a copy of combined class and log-file map 244.

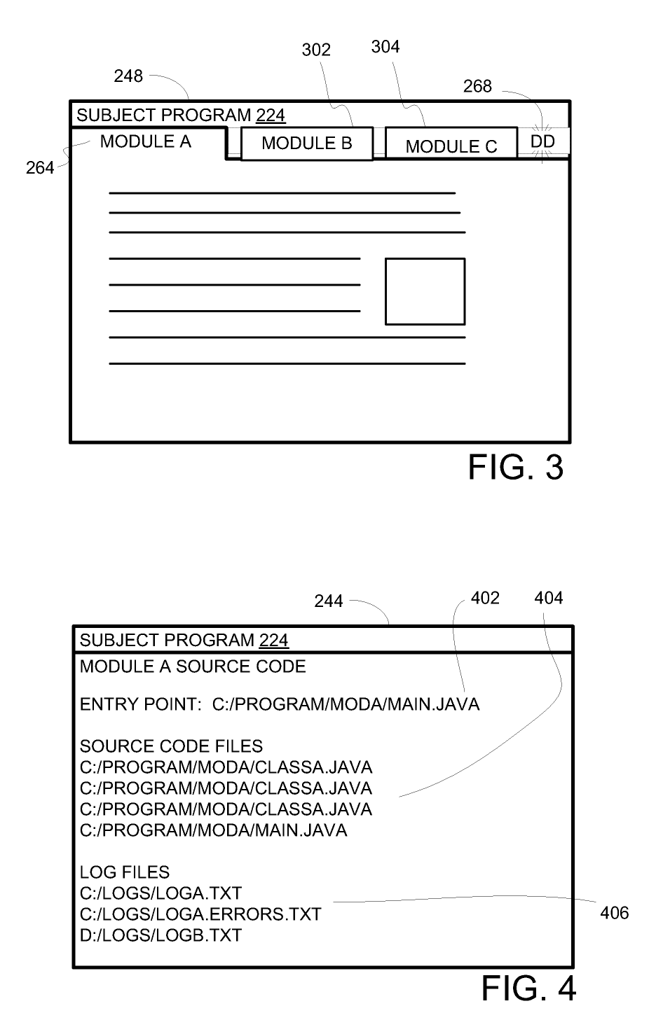

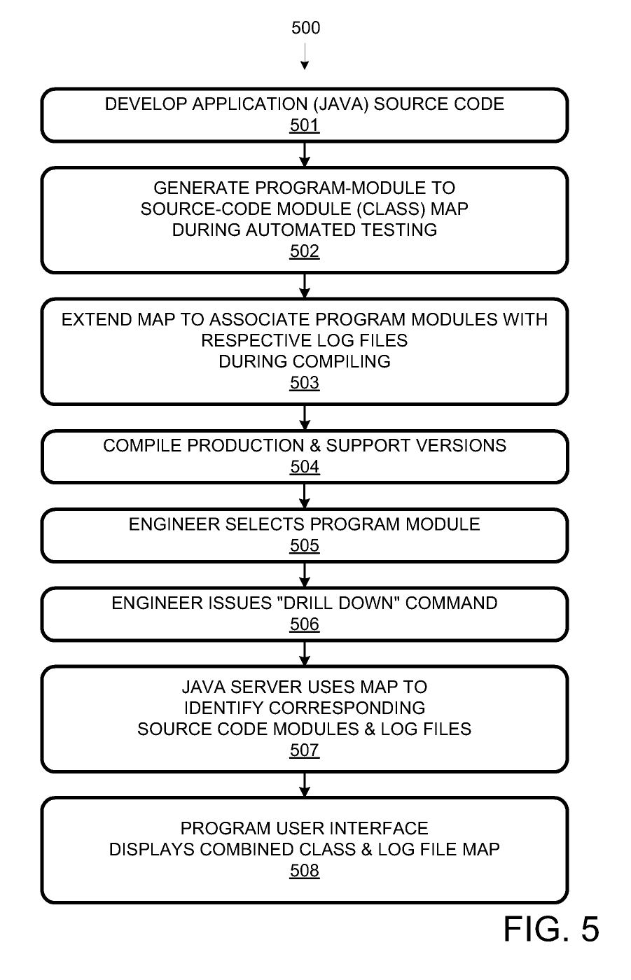

An example of support version 248 is shown in FIG. 3 with tabular program modules 262, including module A 264, module B 302, and module C 304. Module A 264 is active and, so, is shown in front of the other modules. The user interface for module A 264 includes drill-down button 268, which, when activated, e.g., by pointing and clicking, causes a drill-down command to be issued; the drill-down command, in turn, causes combined class and log-file map 244 to be displayed, e.g., on the computer monitor used to display the user interface in FIG. 3, in human readable form. The human readable form of map 244 is shown in FIG. 4. As displayed as shown in FIG. 4, combined map 244 displays the name of a main entry point at 402, names of classes referenced by module A 264, and names of log files 406 in which events associated with module A 264 are logged.

Software eco-system 200 provides for a process 500 to be implemented. At 501, a programmer uses JAVA development system 212 to develop a program in the form of JAVA source code 232 and including logging-mechanism configuration files 234. At 502, source code 232 is tested using test controller 236; in the process JAVA mapping aspect 240 is used to generate class map 242 of program modules to JAVA classes. At 503, log-file mapper 216 maps program modules to log files by associatively combining class map 242 and logging-mechanism configuration files 234 to yield combined map 244.

At 505, an engineer (e.g., a software-development or support engineer) selects a program module, e.g., in response to a request to add a feature or to address a program fault. Selection here can involve making a program module active or naming it in a command line command. At 506, the engineer issues a “drill down” command, e.g., by clicking on drill-down button 268 (FIG. 3). At 507, support version 248 uses map 244 to identify the JAVA classes and log files associated with the selected (active) program module. At 508, support version 248 displays map 244, e.g., as shown in FIG. 4.

Herein, a “system” is a set of interacting non-transitory tangible elements, wherein the elements can be, by way of example and not of limitation, mechanical components, electrical elements, atoms, physical encodings of instructions, and process segments. Herein, “process” refers to a sequence of actions resulting in or involving a physical transformation. “Storage medium” and “Storage media” refer a system including non-transitory tangible material in or on which information is or can be encoded so as to be readable by a computer. Herein, “computer-readable” refers to storage media in which information is encoded in computer-readable form. Herein, a “process” is a device for executing computer instructions encoded in computer-readable media; a processor can be in the form of a single integrated circuit, a portion of an integrated circuit, or a set of integrated circuits.

Herein, unless preceded by the word “virtual”, “machine”, “device”, and “computer” refer to hardware or a combination of hardware and software. A “virtual” machine, device or computer is a software analog or representation of a machine, device, or server, respectively, and not a “real” machine, device, or computer. A “server” is a real (hardware or combination of hardware and software) or virtual computer that provides services to computers. Herein, unless other apparent from context, a functionally defined component (e.g., compiler, annotator) of a computer is a combination of hardware and software executing on that hardware to provide the defined functionality. However, in the context of code encoded on computer-readable storage media, a functionally-defined component can refer to software. Here, an “active element” is an element of a user interface that can be activated so as to cause a command to be issued.

Herein, “executable” describe code that is executable by a hardware computer or a virtual machine. Herein, “automatic” and its relatives refer to operations performed without human intervention. A source code module can be in the form of a JAVA class.

In this specification, related art is discussed for expository purposes. Related art labeled “prior art”, if any, is admitted prior art. Related art not labeled “prior art” is not admitted prior art. The illustrated and other described embodiments, as well as modifications thereto and variations thereupon are within the scope of the following claims.

What is claimed is:

1. An automated process comprising:
generating a class map from object-oriented programming language source code for a subject program using programmed hardware, said class map mapping program modules of said subject program to classes referenced by said source code; and
generating a log map from said class map and from logging-mechanism configuration files using programmed hardware, said configuration files mapping classes to log files, said log map mapping said program modules to said log files.

2. An automated process as recited in claim 1 wherein said class map is generated at least in part in the course of functional testing of said source code.

3. A process as recited in claim 2 further comprising compiling said source code so as to provide a support byte-code version configured to, in response to selection of a program module and the issuance of a drill-down command, display a list of log files configured to be used while the selected program module is active.

4. A process as recited in claim 3 wherein said compiling results in a user interface for the program module, said user interface including a graphical drill-down button that, when activated, causes said drill-down command to be issued.

5. A process as recited in claim 4 wherein said compiling further provides a production byte-code version of said subject program for use by end users, said production byte-code version lacking a drill-down button that, when activated, causes a drill-down command to be issued.

6. A system comprising:
a programmed hardware class mapper configured to create a class map from object-oriented programming source code for a subject program, said class map mapping program modules of said subject program to classes referenced by said source code; and
a programmed hardware log-file mapper configured to create a log map by transitively combining information from said class map and from logging-mechanism configuration files for said subject program, said configuration files mapping said classes to said log files, said log map mapping said program modules to said log files.

7. A system as recited in claim 6 further comprising a programmed hardware tester for performing functionality tests on said source code, said tester including said class mapper so that said class map is generated at least in part during said functionality testing.

8. A system as recited in claim 6 further comprising a compiler for generating a support version of said subject program, said support version being configured to execute a drill down command and display said log map in response to said drill down command.

9. A system as recited in claim 8 wherein said support version is configured to display an active element that when activated causes said drill-down command to be issued.

10. A system as recited in claim 9 wherein said compiler also generates a production version of said subject program, said production version lacking said drill-down button.

11. A system comprising computer-readable storage media encoded with code defining a compiler configured to, when executed by a processor:
create a class map based on source code of a subject program including said program modules, said class map mapping said program modules to classes referenced by said source code; and
create a log map by combining information from said class map and from logging mechanism configuration files associated with said subject program, said configuration files mapping said classes to log files used while said program modules are executing, said log map mapping said program modules to said log files.

12. A system as recited in claim 11 further comprising said processor.

13. A system as recited in claim 11 wherein said code is further configured to at least partially create said class map in the course of functional testing of said source code.

14. A system as recited in claim 11 wherein said code is further configured to compile said source code into a support version of said subject program that, when a program module of said support version is executing, displays a drill-down element that when activated causes a drill-down command to be issued and causes said log map and/or said class map to be displayed in response to said drill-down command.

15. A system as recited in claim 14 wherein said code is further configured to compile said source code into a production version lacking said drill-down button.
